(19) United States
(12) Patent Application Publication
(10) Pub. No.: US 2011/0018973 A1
(43) Pub. Date: Jan. 27, 2011

(54) THREE-DIMENSIONAL IMAGING DEVICE AND METHOD FOR CALIBRATING THREE-DIMENSIONAL IMAGING DEVICE

(75) Inventor: Jun Takayama, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 12/933,696

(22) PCT Filed: Feb. 25, 2009
(86) PCT No.: PCT/JP2009/053369

§ 371 Date: Sep. 21, 2010

(30) Foreign Application Priority Data
Mar. 26, 2008 (JP) 2008080153

(51) Int. Cl. H04N 13/02

(52) U.S. Cl. 348/47; 348/E13.074; 348/E17.002

(57) ABSTRACT

A three-dimensional imaging device (10) comprises a plurality of imaging devices (11a and 11b), each equipped with imaging elements for converting incident light into electrical signals, and a light emitting device (14) for emitting a laser beam, in which a laser beam (B) from the light emitting device forms a light emission point (A) by plasma in space in front of the imaging device, and the difference in positional relationship with regard to the plurality of imaging devices is calibrated based on the emission point (A) as a base point. Consequently, calibration can be always performed at a required timing regardless of the conditions of an object, and can be performed while keeping a constant accuracy.

### TECHNICAL FIELD

The present invention relates to a three-dimensional imaging device, having plural imaging devices, and a method for calibrating the three-dimensional imaging device.

### BACKGROUND ART

A stereo-camera, mounted on a vehicle, is well-known, the stereo-camera is configured to measure the inter-vehicle distance by plural cameras mounted on the vehicle. Said stereo-camera mounted on the vehicle is required to continuously operate intermittently over a long duration (which is more than a few years), after being mounted on the vehicle. In order to normally operate the stereo-camera, calibration is conducted for the stereo-camera, before its shipment from the factory. However, the relationship between mounting locations of the lens and the imaging element, and the dimensions and the shapes of the structuring members, such as a body, are changed due to secular changes under actual operating environments, whereby the conditions, determined under the initial setting, tend to change. To overcome this problem of the stereo-camera mounted on the vehicle, an object is selected to be a reference, among photographed objects, whereby the object is used for the calibration of the stereo-camera mounted on the vehicle, so that the measuring accuracy is maintained for a long time.

Patent Document 1 discloses a method for calibrating a stereo-camera mounted on a vehicle, in which traffic signals are used. Patent Documents 2 and 3 disclose stereo-cameras having automatic calibrating functions, which use number plates. Further, Patent Document 4 discloses a calibration method and device of a stereo-camera.

### Patent Document 1: Unexamined Japanese Patent Application Publication Number 10-341,458,

### Patent Document 2: Unexamined Japanese Patent Application Publication Number 2004-354,257,

### Patent Document 3: Unexamined Japanese Patent Application Publication Number 2004-354,256,

### Patent Document 4: Unexamined Japanese Patent Application Publication Number 2005-17,286.

### DISCLOSURE OF THE INVENTION

### The Problem to be Solved by the Invention

Conventionally, like the above-described Patent Documents, a reference object is selected among photographed images, and said reference object is used for the calibration. However, the reference object is not always possible to be obtained, whereby, until the reference object is obtained, calibration timing is shifted, which results in irregular calibrations, conducted at irregular timings. Further, the object to be the reference is not always possible to be on the same position, which requires complicated processes for signals obtained from the images, and it is not always possible for the device to obtain a desired accuracy, which are the major problems.

As regarding the above-described problems of the conventional technology, an object of the present invention is to offer a three-dimensional imaging device and a method for calibrating the three-dimensional imaging device, in which the calibration is always possible to be conducted at necessary timings, regardless to the conditions of the object, and the calibration is conducted with a constant accuracy.

### Means to Solve the Problems

In order to achieve the above-described object, a three-dimensional imaging device is characterized to include: plural imaging devices, each includes an imaging element that converts incident light into electrical signals; and a light emitting device that emits a laser beam, wherein a light emission point by plasma is formed in space in front of the imaging devices, and wherein the difference in positional relationship with regard to the plural imaging devices is calibrated based on the light emission point serving as a base point.

Based on this three-dimensional imaging device, since the laser beam is emitted from the light emitting device, the light emission point by plasma is formed in space in front of the imaging devices, whereby the difference in the positional relationship with regard to the plural imaging devices is calibrated based on the light emission point serving as the base point. Accordingly, calibration is possible to be conducted anytime and anywhere, and the calibration is possible to be always conducted at necessary timings, independently to the conditions of the object, while keeping the constant accuracy.

On the above three-dimensional imaging device, it is preferable that the imaging device and the light emitting device are integrally structured.

Further, since the plural light emission points are formed in space by the laser beams, the calibrations are conducted based on the plural light emission points, whereby the plural calibrations can be conducted, based on the plural light emission points as the base points, respectively, so that the accuracy of the calibrations is improved.

A light emission pattern (being a visible spatial image) is formed in space by the laser beams, and the calibration is conducted based on said light emission pattern, whereby a large number of calibrations can be conducted based on a large number of light emission points as the base points, respectively, so that the accuracy of the calibration is improved. In this case, it is possible to structure that the light emission pattern is configured to display information to a vehicle driver.

Still further, when the device is to be activated, the laser beams are emitted to conduct the calibration, so that frequent calibrations can be conducted on starting the device.

Still further, it is also possible to structure that the laser beams are emitted at a predetermined time interval, so that the calibration is conducted at the predetermined time interval.

Still further, invisible light of long wave length or short wave length can be used as the laser beams.

The method for calibrating the three-dimensional imaging device of the present embodiment is a method for calibrating a three-dimensional imaging device, which is characterized in that plural imaging devices, each incorporates an imaging element to convert incident light to electrical signals, and laser beams are emitted from a light emitting device to an area in front of the imaging device to form a light emission point by plasma in space in front of the imaging device, whereby any difference in positional relationship with regard to the plural imaging devices is calibrated based on the emission point as a base point.

Based on said three-dimensional imaging device, the laser beams are emitted from the light emitting device to form the light emission point by plasma in space in front of the imaging device, whereby any difference in positional relationship with regard to the plural imaging devices can be calibrated based on the emission point as a base point. Accordingly, for the three-dimensional imaging device, calibration can be conducted anytime and anywhere, and calibration is possible to always be conducted at necessary timings, independently to the conditions of the object, while keeping the constant accuracy.

### EFFECT OF THE INVENTION

Based on the three-dimensional imaging device of the present invention, calibration is possible to always be conducted at necessary timings, independently to the conditions of the object, while keeping the constant accuracy.

### BRIEF DESCRIPTION OF THE DRAWINGS

FIG. 1 is a drawing to show a structure of relevant parts of a three-dimensional imaging device.

FIG. 2 is a block diagram to generally show a total structure of the three-dimensional imaging device shown in FIG. 1.

FIG. 3 is a flow chart to explain a calibration step of a stereo-camera of the three dimensional imaging device shown in FIG. 1 and FIG. 2.

FIG. 4 is a drawing to show a structure of relevant parts of another three-dimensional imaging device.

FIG. 5 is a drawing to show a general structure of a laser beam emitting device of the three-dimensional imaging device shown in FIG. 4.

FIG. 6 is a drawing to show a structure of relevant parts of still another three-dimensional imaging device.

### EXPLANATION OF SYMBOLS

10, 30, and 40 three dimensional imaging devices
1 and 3 lenses
2 and 4 imaging elements
11 stereo-camera
11a base camera
11b reference camera
14, 24 and 34 laser emitting devices
27 optical scanning section
A light emission point, light focusing point
B laser beam
C-I light emission points

### THE BEST EMBODIMENT TO ACHIEVE THE INVENTION

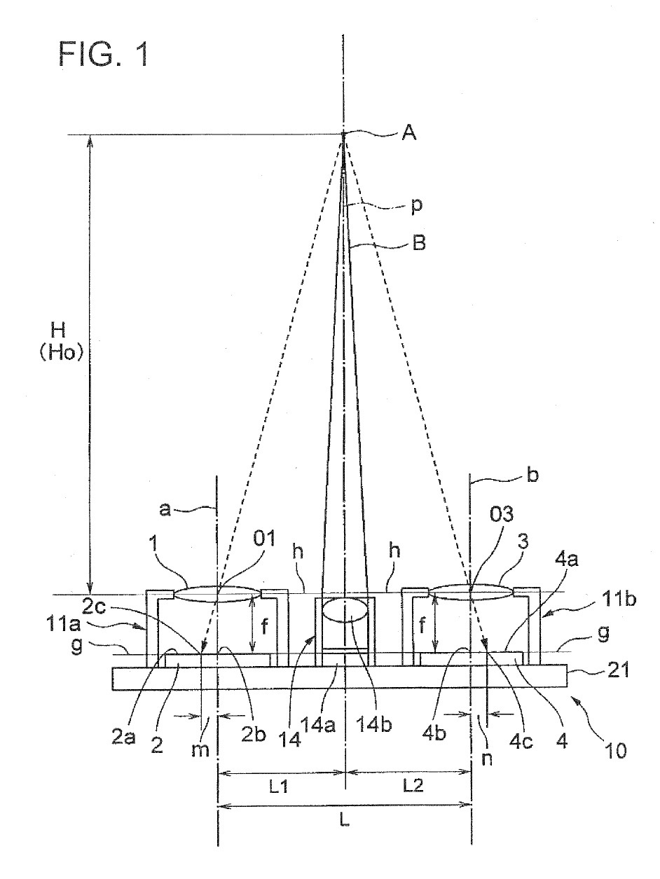

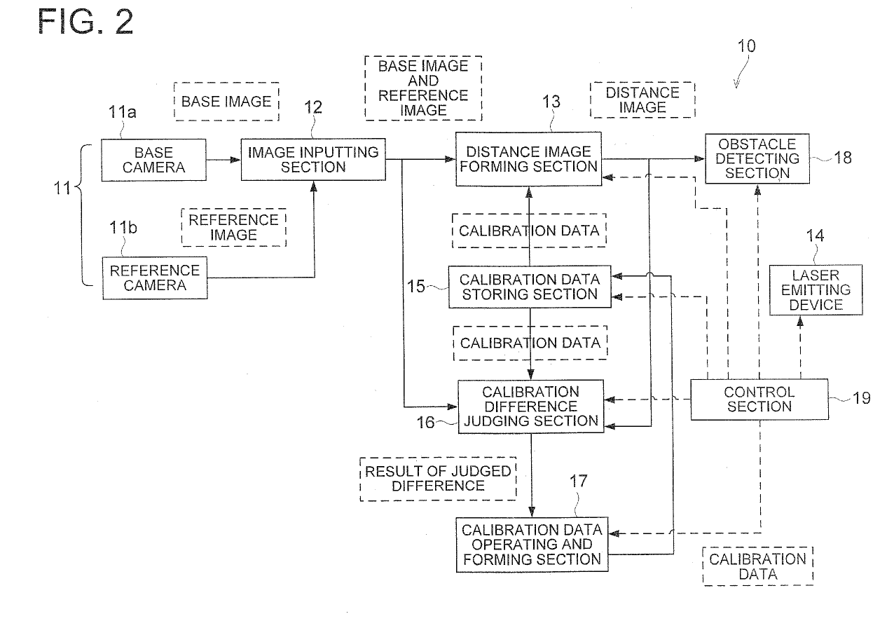

The best embodiment to achieve the present invention will now be detailed while referring to the drawings. FIG. 1 is a drawing to show a structure of relevant parts of the three-dimensional imaging device. FIG. 2 is a block diagram to generally show a total structure of the three-dimensional imaging device.

As shown in FIG. 1 and FIG. 2, a three-dimensional imaging device 10 of the present embodiment is provided with a stereo-camera 11 and a laser oscillator (being an emitting device) 14. The stereo-camera 11 is structured of a base camera (being a photographing device) 11a, having a lens 1 and an imaging element 2, and a reference camera (being a photographing device) 11b, having a lens 3 and an imaging element 4. The laser emitting device 14 is provided with a laser light source 14a, structured of a semiconductor laser device to generate invisible light rays, such as infrared light rays or ultraviolet light rays, and a lens optical system 14b, structured of a lens.

As shown in FIG. 2, a three-dimensional imaging device 10, mounted on a vehicle, is provided with the stereo-camera 11, an image inputting section 12 which is configured to receive data of a base image from camera 11 and data of a reference image from camera 11b, a distance image forming section 13 which is configured to form a distance image, based on a stereo-image, structured of the base image and the reference image, the laser emitting device 14, a calibration data holding section 15, a calibration difference judging section 16, a calibration data operating and forming section 17, an obstacle detecting section 18 which is configured to detect a leading vehicle or a pedestrian, based on the distance image, formed by the distance image forming section 13, and a control section 19 which is configured to control above sections 11-18.

As shown in FIG. 1, the base camera 11a of the stereo-camera 11 is structured of an optical system, including lens 1 with a focal length “f”, and an imaging element 2, structured of a CCD and a CMOS image sensor, while the reference camera 11b is structured of an optical system, including lens 4 with a focal length “f”, and an imaging element 4, structured of a CCD and a CMOS image sensor. As shown in FIG. 2, respective data signals of the images, photographed by the imaging elements 2 and 4, are outputted from the imaging elements 2 and 4, whereby the base image is obtained by the imaging element 2 of the base camera 11a, while the reference image is obtained by the imaging element 4 of the reference camera 11b.

As shown in FIG. 1, base camera 11a, reference camera 11b, and laser emission device 14, are integrated on a common plate 21 of the three-dimensional imaging device 10, to be a predetermined positional relationship.

The laser emission device 14 is arranged between the base camera 11a and the reference camera 11b, so that laser beam B, emitted from the laser light source 14a, are concentrated on a point A in space, whereby the light emission is generated on the concentrated point (being a light emission point) A.

The plasma emission, due to the concentrated laser beams in the air, is a well-known physical phenomenon. For example, according to “Three-Dimensional (being 3D) Image Coming Up in Space” (TODAY of AIST, 2006-04 Vol. 6, No. 04, pages 16-19) (http://www.aist.go.jp/aist_j/aistinfo/aist_doday/vol06_{—}04/vol06_{—}04_topics/vol06_{—}04_topics.html), disclosed by Advanced Industrial Science and Technology as the Independent Administrative Corporation, the plasma emission is detailed as below.

That is, when the laser beams are strongly concentrated in the air, extremely large energies are concentrated adjacent to the focal point. Then, molecules and atoms of nitrogen and oxygen, structuring the air are changed to be a condition called “plasma”. The plasma represents a condition in that large energies are confined, whereby when the energies are discharged, white light emission is observed adjacent to the focal point. Said phenomena is characterized in that the light emission is observed only near the focal point, and nothing is superficially observed on the light paths (which occurs more effectively, when invisible laser beams are used).

Further, concerning the visual air image forming device and method, using the above physical phenomena, are disclosed in Un-examined Japanese Patent Application Publication Nos. 2003-233,339 and 2007-206,588.

The concentrating point (being the light emission point) A by the laser emission device 14 is fixed at a constant distance within 0.5-3 m in front of the three-dimensional imaging device 10. Said distance can be set by the focal length of the lens optical system 14b of the laser emission device 14. Since the light emission point A is fixed, the laser emission device 14 can be simply structured without including a driving system.

As detailed above, the laser emission device 14 is mounted at the center between two cameras 11a and 11b, and the light emission point A by the plasma emission is formed in space at a constant distance from cameras 11a and 11b. Said light emission point A is determined to be the base point A, whereby the positional difference of two cameras 11a and 11b can be calibrated.

As shown in FIG. 1, concerning the imaging element 2 of the base camera 11a and the imaging element 4 of the reference camera 11b, imaging surfaces 2a and 2b are arranged on a common surface “g”, and the lenses 1 and 3 are an so that an optical axis “a” passing through a lens center O1 and an optical axis “b” passing through a lens center O2 are parallel to each other, and the lenses 1 and 3 are further arranged with a horizontal lens center distance L. The common surface g of imaging surfaces 2a and 4a are separated in parallel from a lens surface h at the focal length “f”. A horizontal distance, which is between the base points 2b and 4b, at which the optical axes “a” and “b” cross at right angles with the imaging surfaces 2a and 4a, is equal to the horizontal lens center distance L.

In FIG. 1, an optical axis p of the laser emitting device 14 is perpendicular to the common surface g of the imaging surfaces 2a and 4a Concerning a distance L1 between the optical axis p and the optical axis “a” of the lens 1, a distance L2 between the optical axis p and the optical axis “b” of the lens 3, and the lens center distance L, a relational expression (1) is established as shown below.

L1+L2=L (1)

Next, an object whose distance is to be measured is set as the light emission point A on the optical axis p, and a distance H is set from the lens surface h to the light emission point A. As shown by the dotted lines in FIG. 1, the light rays from the light emission point A pass through the center O1 of the lens 1 of the base camera 11a, and are focused on a focusing position 2c on the imaging surface 2a, while the light rays from the light emission point A pass through the center O3 of the lens 3 of the reference camera 11b, and are focused on a focusing position 4c on the imaging surface 4a. A distance m, which is from the base point 2b on the imaging surface 2a of the base camera 11a to the focusing point 2c, and a distance n, which is from the base point 4b on the imaging surface 4a of the reference camera 11b to the focusing point 4c, both represent shifting amounts (being a parallax), which occur due to the arrangements of the base camera 11a and the reference camera 11b, separated by the distance L. Since H/L1=f/m, and H/L2=f/n in FIG. 1, expressions (2) and (3) are obtained as below.

H=(L1·f)/m (2)

H=(L2·f)/n (3)

In the present embodiment shown by FIG. 1, L1=L2, whereby L1=L2=L/2 is obtained from the expression (1). Accordingly, expressions (4) and (5) are obtained as below

H=(L·f)/2m (4)

H=(L·f)/2n (5)

Since the distance L between the centers of the lenses and the focal distance f are constant values, the distance H to the light emission point A can be measured by the shifting amounts m and n. That is, by the theory of triangulation, the distance H to the light emission point A can be measured based on information from the stereo-camera 11.

The distance image forming section 13 forms the distance images of the base image and the reference image, based on the image data from the stereo-camera 11, and conducts parallax operations. For the parallax operations, a corresponding point concerning the distance image is researched. For the research of the corresponding point, a correlation method or a phase-only correlation method, being POC, using the sum of absolute difference, being SAD, are used. In detail, distance image forming section 13 processes the operations of the SAD method or the POC method, by the integrated elements, as a hardware method. Otherwise, it can processes the operations by CPU (being a Central Processing Unit), as a software method. In this case, the CPU conducts predetermined operations in accordance with predetermined programs.

In the present embodiment, as detailed above, the distance, which is between the laser emission device 14 and the light emission point A formed by the laser beam B, is constant as a known distance. The light emission point A is set as a base point, whereby while the known distance Ho to the light emission point A is used, the positional difference between the two cameras 11a and 11b is detected and the calibration is conducted, on the three dimensional imaging device 10.

That is, the calibration difference judging section 16 in FIG. 2 detects the positional difference on the stereo-camera 11, and judges an existence of the positional difference. The positional difference on the stereo-camera 11 means that, due to the positional difference of camera 11a and camera 11b, the inclinations of the optical axis “a” and the optical axis “b”, the degrees of parallelization of the optical axis “a” and the optical axis “b”, and the difference of the lens center distance L, in FIG. 1, an error is generated on the distance detected by the three dimensional imaging device 10, or the epipolar line on the image is shifted.

The calibration data storing section 15 stores the known distance Ho, which is between the laser emitting device 14 and the light emission point A formed by the laser beam B, and the calibration data. The distance image forming section 13 measures the distance H which is between the distance image and the light emission point A. Calibration difference judging section 16 compares the measured distance H with the known distance Ho, and determines whether the positional difference exists. For example, if the distance H equals to the distance Ho, or if the difference between them is within a predetermined value, said section 16 determines that no positional difference exists. If the difference is greater than the predetermined value, said section 16 determines that the positional difference exists. Said section 16 sends the judged result concerning the difference to the calibration data operating and forming section 17.

The calibration data operating and forming section 17 conducts the operation and the formation of the calibration data, such as the degree of parallelization of the stereo-camera 11, whereby the calibration data storing section 15 stores formed calibration data.

The distance image forming section 13 corrects a distance error, based on the calibration data, sent from the calibration data storing section 15. Further, said section 13 forms a distance image, while correcting the epipolar line on the image.

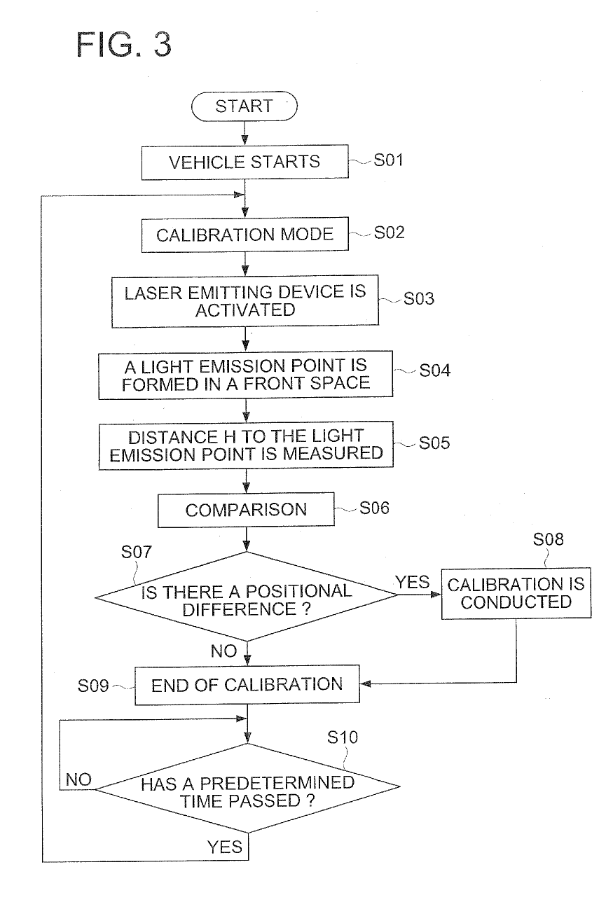

The control section 19 in FIG. 2 is provided with a CPU (Central Processing Unit) and a memory medium, such as a ROM in which the programs for forming and calibrating the above-described distance image, and the CPU controls each step shown in the flow chart of FIG. 3, in accordance with the programs read from the memory medium.

The calibration steps of the stereo-camera 11 of the three dimensional imaging device, shown in FIG. 1 and FIG. 2, will be detailed, while referring to the flow chart of FIG. 3.

Firstly, when the vehicle is started (S01), the three-dimensional imaging device 10 enters a calibration mode (S02), and the laser emitting device 14 is activated (S03). Due to this, the light emission point A, shown in FIG. 1, is formed by the plasma in space in front of the vehicle (S04).

Next, the distance image forming section 13, shown in FIG. 2, measures the distance H to the light emission point A (S05), and the calibration difference judging section 16 compares the measured distance H with the known distance Ho (S06), if any positional difference exists (S07), the calibration is conducted by the following method (S08).

That is, a difference judging result of the calibration difference judging section 16 is outputted to the calibration data operating and forming section 17, whereby the calibration data operating and forming section 17 operates and forms calibration data, such as the degree of parallelization of the stereo-camera 11, based on the above-described judging result, and the calibration data storing section 15 stores said calibration data. The distance image forming section 13 corrects the distance error, based on the calibration data from the calibration data storing section 15, and corrects the epipolar line on the image to form a distance image.

If no positional difference exists (S07), or after the above-described calibration has been conducted (S08), the calibration mode is completed (S09). Further after a predetermined time has passed (S10), the operation is returned to step S02, so that the calibration is conducted in the same way.

As described above, based on the three-dimensional imaging device 10, since the laser beam is emitted from the laser emitting device 14, the light emission point A by plasma is formed in space in front of the vehicle, whereby the difference in the positional relationship with regard to the stereo-camera 11 is calibrated based on the light emission point A serving as the base point. Accordingly, calibration is possible to be conducted almost anytime and anywhere, and calibration is possible to be always conducted at necessary timings, independently of the conditions of the object, while keeping the constant accuracy.

Since the three-dimensional imaging device 10, shown in FIG. 1 and FIG. 2, is configured to use the obstacle detecting section 18 to detect the leading vehicle and the pedestrian, after said device 10 measures the distance to the leading vehicle, said device 10 sends detected and measured information to the vehicle driver by image or sound. By adequately conducting the above-described calibration, said device 10 can improve said detected and measured information more accurately.

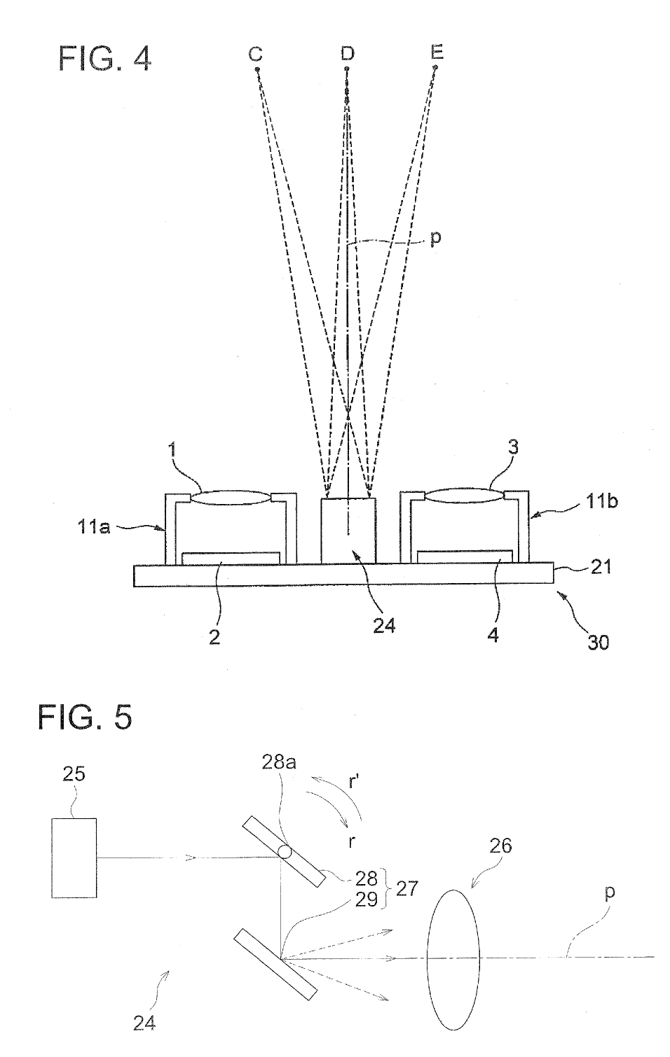

Next, another three-dimensional imaging device is detailed, while referring to FIG. 4 and FIG. 5, in which plural light emission points are formed by the laser emitting device in space, and the stereo-camera is calibrated by the plural light emission points, serving as the base points. FIG. 4 shows the relevant parts of said three-dimensional imaging device. FIG. 5 is a drawing to show a general structure of the laser emitting device of the three-dimensional imaging device shown in FIG. 4.

A three-dimensional imaging device 30, shown in FIG. 4, forms plural light emission points in space by a laser emitting device 24, other than one which has the same structures as detailed in FIG. 1 and FIG. 2. The laser emitting device 24 is mounted between the base camera 11a and the reference camera 11b, and controlled by the control section 19 in FIG. 2.

As shown in FIG. 5, the laser emitting device 24 is provided with a laser light source 25, structured of a semi-conductor laser to generate invisible light rays, such as the infra-red or ultraviolet light rays, an optical lens system 26, and an optical scanning section 27.

The optical scanning section 27 is structured of

a rotational reflection member 28, which is pivoted on rotational shaft 28a, to be rotated by a driving means, such as a motor (which is not illustrated), in a rotating direction “r” and an opposite rotating direction “r′”, and receives the laser rays from the laser light source 25, and

a reflection member 29 to reflect the laser rays, sent from the rotational reflection member 28. The laser rays, emitted by the laser light source 25, are reflected by the rotational reflection member 28 and the reflection member 29, and go out from the optical lens system 26. When the rotational reflection member 28 is rotated around the rotational shaft 28a, in the rotating directions “r′” and “r”, the laser rays are reflected to scan in the rotating directions. Due to scanning movements, the laser rays diverge against the optical axis “p”, and enter the optical lens system 26, after that, the laser rays run to incline against the optical axis “p”, as shown in FIG. 4.

Accordingly, as shown in FIG. 5, plural light emission points C, D and E are formed in space. Since the distances to the plural light emission points C, D and E are constant and invariable, the plural light emission points C, D and E can be the base points, so that calibrations can be conducted in the same way as above, in plural times, which is a more accurate way.

Since the plural light emission points C, D and E are to be formed when the calibration is conducted, and said points are not necessary to be formed at the same time. Accordingly the following procedures are possible to be used in which, when the laser rays are scanned, the rotational reflection member 28 is rotated at a predetermined angle and stopped, so that light emission point C is formed, after that, said member 28 is rotated to a central position, so that the light emission point D is formed, subsequently said member 28 is rotated in the opposite direction at the predetermined angle and stopped, so that the light emission point D can be formed.

Further, the rotational reflection member 28 has been used as the optical scanning section 27. As section 27 is not limited to this member 28, other optical scanning members can be used. For example, a refraction member, such as a prism, can be mounted on the optical axis “p”, the refraction member is positioned to be changed around the optical axis “p”, to conduct the optical scanning operation. Further, the optical scanner, such as a micro-electromechanical system (MEMS), can also be used. Yet further, the position of the rotational reflection member 28 in FIG. 5 can be changed to the position of the reflection member 29.

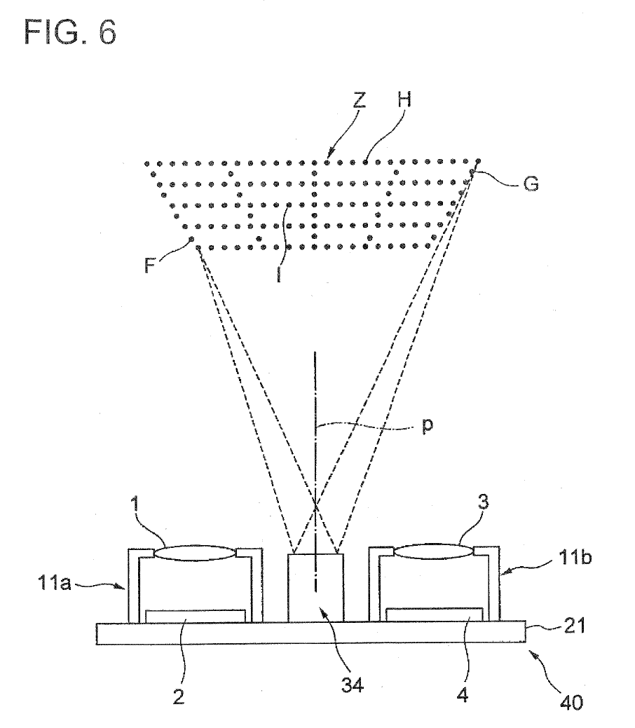

Next, still another three-dimensional imaging device is detailed while referring to FIG. 6, in which light emission points are formed by the laser emitting device in space, and the stereo-camera is calibrated by the plural light emission points, serving as the base points. FIG. 6 shows the relevant parts of said three-dimensional imaging device.

A three-dimensional imaging device 40, shown in FIG. 6, forms a light emission pattern formed of plural light emission points in space by a laser emitting device 34, device 40 has the same structures as the one detailed in FIG. 1 and FIG. 2, other than said light emission points. The laser emitting device 34 is mounted between the base camera 11a and the reference camera 11b, and controlled by the control section 19 in FIG. 2.

In the same way as shown in FIG. 5, the laser emitting device 34 is provided with a laser light source 25, structured of a semi-conductor laser to generate invisible light rays, such as infra-red or ultraviolet light rays, an optical lens system 26, and an optical scanning section 27. The optical scanning section 27 can scan in two different directions, using the laser rays emitted from the laser light source 25. For example, using FIG. 5, reflection member 29 is configured to rotate in the same way as the rotational reflection member 28, but the rotating direction of the member 29 is configured to differ from that of the rotational reflection member 28. Accordingly, the scanning operation is conducted in the different two directions, while using the laser rays emitted by the laser light source 25, whereby a lattice pattern Z can be formed in space, as a two-dimensional arbitrary pattern, shown in FIG. 6.

As detailed above, since the distances to the plural light emission points F, H and I, being predetermined points, of the lattice pattern Z formed in space, are constant and invariable, the plural light emission points F, G, H and I can be the base points, so that calibrations can be conducted the same way as above, in plural times greater than the case of FIG. 4, which is a more accurate way.

Further, the pattern formed in space can be used for a display of information, so that it is also possible for use, to combine the display of notice to the vehicle driver and the calibration of stereo-camera 11. For example, information to the vehicle driver is formed in space in front of the vehicle, so that the pattern can be used for information to the vehicle driver. Information to the vehicle driver is not limited to any specific one. For example, information for fastening the seat belt and information concerning the vehicle maintenance are listed for use. Further, by combining with the navigation system mounted on the vehicle, information for the directional indication, information for a traffic jam, and information for names of places can be displayed.

Still further, as the optical scanning section of the laser emitting device 34, an optical scanner of the MEMS type can also be used in the same way as above mode. In this case, a one-dimensional scanner is individually arranged on the positions of reflection members 28 and 29 of FIG. 5, or a two-dimensional scanner is individually arranged on the positions of reflection members 28 and 29. Other optical scanning members, such as a Galvano-mirror or a polygonal mirror, can also be used.

The best mode to conduct the present invention has been detailed above, however the present invention is not limited to the above, within the scope of the technical idea of the present invention, various alternations can be used. For example, the three-dimensional imaging device shown in FIGS. 1 and 2 is configured to include the stereo-camera which is structured of two cameras. The present invention is not limited to said two cameras, that is, three cameras or more can be used.

Still further, in FIG. 3, when the vehicle starts, the calibration is automatically conducted, and after a predetermined time has passed, the calibration is automatically repeated. Instead, the calibration can be conducted only when the vehicle starts, or only when the predetermined time has passed, after the vehicle started. Further, the calibration is automatically conducted at a predetermined time interval, without being conducted, when the vehicle starts. Still further, as another method, a manual button is provided on the three-dimensional imaging device 10, so that the calibration can be manually conducted, when the vehicle driver presses the button.

Still further, concerning the distance L1 in FIG. 1, which is between the optical axis “p” of the laser emitting device 14 and the optical axis “a” of the lens 1, and concerning the distance L2, which is between the optical axis “p” and the optical axis “b” of the lens 3, wherein L1 is configured to be equal to L2. Otherwise, the laser emitting device 14 can be arranged so that L1 is not equal to L2.

1. A three-dimensional imaging device comprising:
plural imaging devices, each includes an imaging element that converts incident light into electrical signals; and
a light emitting device that emits laser beams,
wherein the laser beams from the light emitting device are configured to form a light emission point by plasma in a air in front of the imaging devices, and
wherein a difference in positional relationship with regard to the plural imaging devices is calibrated based on the light emission point serving as a reference point.

2. The three-dimensional imaging device of claim 1,
wherein the imaging device and the light emitting device are integrally structured.

3. The three-dimensional imaging device of claim 1,
wherein the laser beams are configured to form plural light emission points in space, whereby calibrations are conducted based on the plural light emission points.

4. The three-dimensional imaging device of claim 1, wherein the laser beams are configured to form a light emission pattern in space, whereby the calibration is conducted based on the light emission pattern.

5. The three-dimensional imaging device of claim 1, wherein when the device is to be activated, the laser beams are emitted so that the calibration is conducted.

6. The three-dimensional imaging device of claim 1, wherein the laser beams are emitted at a predetermined time interval, so that the calibration is conducted at the predetermined time interval.

7. The three-dimensional imaging device of claim 1, wherein invisible light is used as the laser beams.

8. The three-dimensional imaging device of claim 4, wherein the light emission pattern is configured to display information to a vehicle driver.

9. A method for calibrating a three-dimensional imaging device including plural imaging devices, each having imaging element to convert incident light to electrical signals, comprising the steps of:
emitting laser beams from a light emitting device to space in front of an imaging device;
forming a light emission point by plasma in space in front of the imaging device by the laser beams; and
calibrating difference in positional relationship with regard to the plural imaging devices based on the emission point as a reference point.
